(19) United States
(12) Patent Application Publication
(10) Pub. No.: US 2019/0032687 A1
(43) Pub. Date: Jan. 31, 2019

(54) MEMORY METAL LOCKING MECHANISM

(71) Applicant: Ember Technologies, Inc., Westlake Village, CA (US)

(72) Inventors: Christopher Thomas Wakeham, Solana Beach, CA (US); Daren John Leith, Agoura Hills, CA (US); Mikko Juhani Timperi, San Marcos, CA (US)

(21) Appl. No.: 16/080,999

(22) PCT Filed: Mar. 15, 2017
(86) PCT No.: PCT/US2017/022509

§ 371 Date: Aug. 29, 2018

Related U.S. Application Data
(60) Provisional application No. 62/309,586, filed on Mar. 17, 2016.

(51) Int. Cl. F16B 1/00; A47G 19/22; A47G 19/02

(52) U.S. Cl. CPC F16B 1/0014; A47G 19/02; A47G 19/2205

(57) ABSTRACT

A locking mechanism assembly can include a locking member that can move between a retracted position and a deployed position. A first spring is coupled to a proximal portion of the locking member and exerts a force on the locking member in the proximal direction toward the retracted position. A second spring is coupled to the locking member and exerts a force on the locking member in a distal direction toward the deployed position, opposite to the direction of force exerted by the first spring. One of the first and second springs includes a shape memory material that moves to a pre-deformed state when exposed to heat, thereby increasing in tension such that the force it exerts on the locking member exceeds the force exerted on the locking member by the other of the first and second springs, causing the locking member to move to the retracted or deployed position.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present invention is directed to a locking mechanism, and more particularly to a locking mechanism that utilizes a memory metal and is actuated based on temperature.

### Description of the Related Art

Various types of locking mechanisms are known, such as a key-slot mechanism or quick disconnect mechanism. However, such mechanisms usually require the user to manually actuate the mechanism to lock and unlock the components.

### SUMMARY

There is a need for an improved locking mechanism that operates based on temperature, and that can automatically lock and unlock depending on the temperature the locking mechanism is exposed to.

In accordance with one aspect, a locking mechanism assembly is provided that comprises a spring made of shape memory material that moves a locking member between a retracted position and a deployed position when the shape memory material is exposed to heat. The locking mechanism is optionally implemented in one or both of a drinkware or dishware device and a removable heating puck that can be coupled to a distal portion of the drinkware or dishware device, where the locking mechanism is actuatable to lock the heating puck to the beverage container. The drinkware device can optionally be one of a cup, mug, travel mug, carafe, liquid container, baby bottle, sippy cup, bowl, tureen or reusable water bottle. The dishware device can optionally be one of a plate, platter, serving dish, bread basket, or tortilla warmer.

In accordance with one aspect, a locking mechanism assembly is provided. The assembly comprises a locking member configured to move between a retracted position and a deployed position. The assembly also comprises a first spring coupled to a proximal portion of the locking member, the first spring configured to exert a force on the locking member in the proximal direction toward the retracted position. The assembly also comprises a second spring coupled to the locking member, the second spring configured to exert a force on the locking member in a distal direction toward the deployed position, opposite to the direction of force exerted by the first spring. One of the first and second springs comprises a shape memory material that moves to a pre-deformed state when exposed to heat, thereby increasing in tension such that the force it exerts on the locking member exceeds the force exerted on the locking member by the other of the first and second springs, causing the locking member to move to the retracted or deployed position.

In accordance with another aspect, a device is provided that comprises a first component and a second component detachably coupleable to the first component, the second component comprising a surface and one or more locking mechanism assemblies mounted on the surface. The one or more locking mechanism assemblies comprises a locking member configured to move between a retracted position and a deployed position, a first spring coupled to a proximal portion of the locking member, the first spring configured to exert a force on the locking member in a first direction toward one of the retracted and deployed positions, and a second spring coupled to the locking member, the second spring configured to exert a force on the locking member in a second direction opposite the first direction toward the other of the retracted and deployed positions, the second spring comprising a shape memory material, where the second spring moves to a pre-deformed state when exposed to heat, thereby increasing in tension such that the force exerted by the second spring on the locking member exceeds the force exerted on the locking member by the first spring, causing the locking member to move in the second direction, and wherein the second spring moves to a deformed state when cooled below a predetermined level, thereby decreasing in tension such that the force exerted by the first spring on the locking member exceeds the force exerted on the locking member by the second spring, causing the locking member to move in the first direction. The second component comprises one or more elements configured to generate one or more of heating and cooling of the surface to move the locking member to the deployed or retracted position to lock or unlock the second component to the first component.

### BRIEF DESCRIPTION OF THE DRAWINGS

FIG. 1 shows a schematic view of one embodiment of a locking mechanism in one operating state.

FIG. 2 shows a schematic view of the locking mechanism of FIG. 1 in a second operating state.

FIG. 3 shows a schematic view of one embodiment of a locking mechanism attached to a component in one operating state.

FIG. 4 shows a schematic view of the locking mechanism of FIG. 2 in a second operating state.

FIG. 5A shows one embodiment of a device with a detachable unit detached from the device via an embodiment of a locking mechanism.

FIG. 5B shows the device and detachable unit of FIG. 5B when removably coupled to each other.

FIG. 5C shows a schematic top view of a detachable unit used with the device.

### DETAILED DESCRIPTION

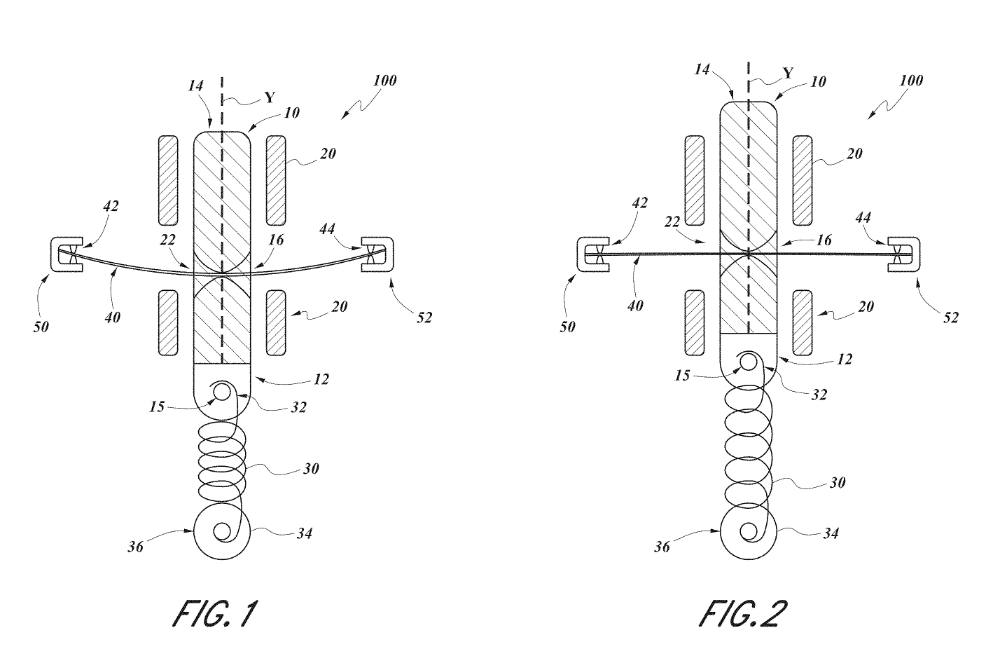

FIG. 1 shows one embodiment of a locking mechanism assembly 100 in a first operating state or position (i.e., and unlocked state or position). The locking mechanism assembly 100 can include a locking member 10 that extends between a proximal end 12 and a distal end 14 and can move between an unlocked position and a locked position. In one embodiment, the locking member 10 can be a pin that travels along an axis Y. However, the locking member 10 can be other suitable types (e.g., a pivotable lever).

In the illustrated embodiment, the locking member 10 can travel along an axis Y within a guide 20. As shown in FIG. 1, the proximal end 12 of the locking member 10 can have an attachment member 15 (e.g., hole, pin, screw that extends transverse to the length of the locking member 10) to which one end 32 of a spring 30 can be attached. The spring 30 can have a second end 34 attached to a fixed attachment member 36 (e.g., pin, screw). In one embodiment, the spring 30 can be a coil spring.

With continued reference to FIG. 1, the locking member 10 can have an aperture or opening 16 that extends generally transversely across a width of the locking member 10 (e.g., extends transversely to a length of the locking member 10). In one embodiment, the aperture or opening 16 can be a bored hole through the width of the body of the locking member 10. In one embodiment, the aperture or opening 16 can be located along the length of the locking member 10 at a location that is between the proximal 12 and distal ends 14 of the locking member 10. In another embodiment, the opening or aperture 16 can be located at the proximal end 12 of the locking member. For example, the aperture or opening 16 can be at the proximal end 12 of the locking member 10 and define the attachment member 15 to which the spring 30 couples. In another embodiment (not shown), the aperture or opening 16 is not defined through the body of the locking member 10, but rather is defined in a loop attached (e.g., integrally attached) to an outer surface of the locking member 10.

The locking mechanism assembly 100 can also include a spring 40 that has a first end 42 fixed at a first attachment member 50 (e.g., pin, screw, clamp or crimped portion) and a second end 44 fixed at a second attachment member 52 (e.g., pin, screw, clamp or crimped portion). The spring 40 can extend through the aperture or opening 16 in the locking member 10 such that the spring 40 extends generally transversely to the length of the locking member 10. In the illustrated embodiment, the spring 40 has a leaf spring configuration. However, other configurations are possible. The spring 40 can be made of a shape-memory material (e.g., a shape memory alloy, such as Nitinol) that can be deformed, but return to its pre-deformed shape when heated.

FIG. 1 shows the spring 40 in a deformed state, where the force exerted by the spring 30 on the locking member 10 is greater than the force applied by the spring 40, such that the spring 30 pulls the locking member 10 toward the fixed attachment member 36, thereby deforming or flexing (e.g., bending) the spring 40.

FIG. 2 shows the spring 40 in its pre-deformed state to which it returns when heated, which causes the spring 40 to exert a force on the locking member 10 away from the fixed attachment member 36 that is greater than the force exerted on the locking member 10 by the spring 30. Said force exerted by the spring 40 causes the locking member 10 to move distally such that the distal end 14 of the locking member 10 extends past an end of the guide 20. In one embodiment, once the distal end 14 of the locking member 10 moves distally past the end of the guide 20, it engages a corresponding opening, aperture or slot (not shown) on a separate component, thereby coupling (e.g., locking) said separate component with the component to which the locking mechanism assembly 100 is attached to (e.g., the component the fixed attachment member 36 and first and second attachment members 50, 52 are attached to). Once the spring 40 is cooled, the force exerted by the spring 30 becomes greater than the force exerted by the spring 40 (e.g., because the tension on the spring 40 decreases), allowing the spring 30 to pull the locking member 10 in a proximal direction such that its distal end 14 does not extend past the guide 20 (e.g., so that the distal end 14 does not engage said separate component), thereby decoupling (e.g., unlocking) said separate component from the component to which the locking mechanism assembly 100 is attached to.

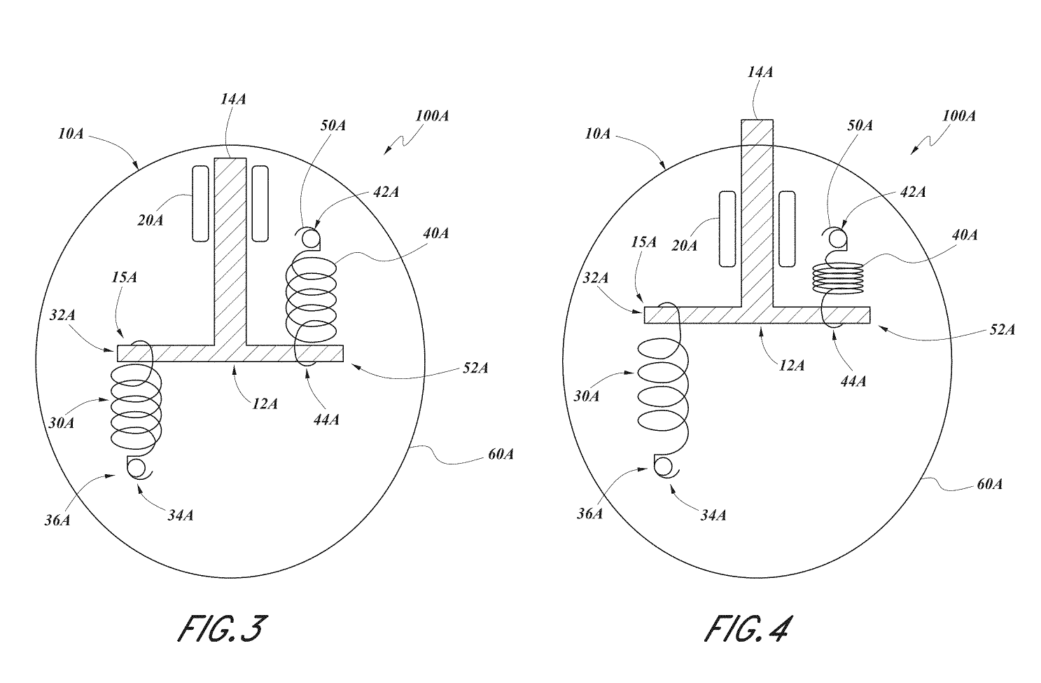

FIGS. 3-4 show another embodiment of a locking mechanism assembly 100A. Some of the features of the locking mechanism assembly 100 are similar to features of the locking mechanism assembly 100 in FIGS. 1-2. Accordingly, references numerals used to designate the various features of the locking mechanism assembly 100A are identical to those used for identifying the corresponding features of the locking mechanism assembly 100 in FIGS. 1-2, except that an “A” has been added to the reference numeral. Therefore, the structure and description for the various features for the locking mechanism assembly 100 in FIGS. 1-2 is understood to apply to the corresponding features of the locking mechanism assembly 100A in FIGS. 3-4, except as described below.

In the illustrated embodiment, the locking mechanism assembly 100 can be attached or mounted on a component 60A, such as a generally planar surface. The proximal end 12A of the locking member 10 can be t-shaped. As shown in FIGS. 3-4, the spring 40A made of a shape memory material, can be a coil spring with one end 42A attached to a first attachment member 50A (e.g., hole, pin, screw) and a second end 44A attached to a second attachment member 52A (e.g., hole, pin, or screw on one side of the T-shaped portion of the proximal end 12A). The spring 30A can have a first end 32A attached to an attachment member (e.g., hole, pin, screw) 15 on an opposite side of the T-shaped portion of the proximal end from which the spring 40A attaches. The spring 30A can have a second end 34A attached to a fixed attachment member 36A (e.g., hole, pin, screw) on the component 60A.

FIG. 3 shows the position of the locking mechanism assembly 100A in the retracted or unlocked state, where the distal end 14A of the locking member 10A does not extend past the edge of the component 60A. This position can occur when the spring 40A is not heated (e.g., is cooled), allowing the force exerted by the spring 30A to exceed the force exerted by the spring 40A, causing the locking member 10 to move in a proximal direction to the retracted (or unlocked) position.

FIG. 4 shows the position of the locking mechanism assembly 100A in the deployed or locked state, where the distal end 14A of the locking member 10A extends past the guide 20A and past the edge of the component 60A (e.g., to engage an opening, aperture or slot on another component attached to the component 60A to lock the two components together). This position can occur when the spring 40A is heated (e.g., by heating a surface of the component 60A), causing the coil spring 40A to contract (e.g., to increase in tension force) so that the force exerted by the spring 40A exceeds the force exerted by the spring 30A, which causes the locking member 10 to move in a distal direction to the deployed (or locked) position.

The embodiments above describe the spring 40, 40A as being made of a shape memory material (e.g., a shape memory alloy, such as Nitinol) and the spring 30, 30A is made of a conventional material (i.e., non-shape memory material). In these embodiments, the locking member 10, 10A is generally biased in the retracted (unlocked) position by the spring 30, 30A, until the spring 40, 40A is exposed to heat, such that the spring 40, 40A exerts a force on the locking member 10, 10A toward the deployed (or locking) position. However, in another embodiment, the spring 30, 30A can be made of a shape memory material (such as Nitinol), and the spring 40, 40A can be made of a conventional material (e.g., a non-shape memory material). In such an embodiment, the locking member 10, 10A can be generally biased in the deployed position by the spring 40, 40A, until the spring 30, 30A is exposed to heat, such that the spring 30, 30A exerts a force on the locking member 10, 10A toward a retraced (or unlocked) position.

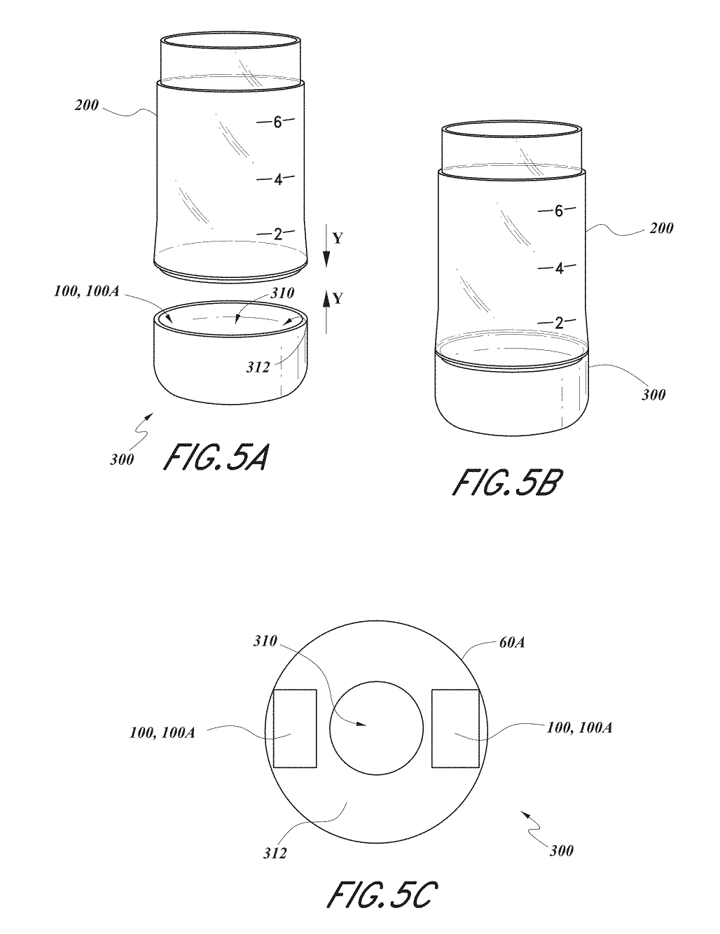

FIGS. 5A-5C show one embodiment of a device that incorporates one or more locking mechanism assemblies 100, 100A. In the illustrated embodiment, the device is a container 200 with a detachable unit 300 that attaches to a bottom of the mug 200 (e.g., by moving one or both of the container 200 and unit 300 axially toward each other along direction Y). FIG. 5A shows a perspective view of the unit 300 when detached from the container 200. FIG. 5B shows a perspective view of the unit 300 coupled to the container 200. The detachable unit 300 can have a one or more heating elements or surfaces (or cooling elements, or heating/cooling elements) 310 that can contact a bottom surface of the container 200 when the heating unit 300 is coupled to the container 200 to heat the liquid in the container 200 via conduction heat transfer through the base of the container 200. In one embodiment, at least the base of the container can be made of a material with good thermal conductivity properties (e.g., metal). The heating unit 300 can also have a surface 312 on which one or more of the locking mechanism assemblies 100, 100A can be mounted (e.g., as shown in FIGS. 1-4), where the one or more locking mechanism assemblies 100, 100A can operate as discussed herein. In one embodiment, the one or more heating elements 310 can be one or more resistive heaters. In another embodiment, the one or more heating/cooling elements 310 can be one or more thermoelectric elements (e.g., Peltier elements). Further details of detachable heating units can be found U.S. application Ser. No. 14/712,313, which is incorporated herein in its entirety and should be considered a part of this specification.

With continued reference to FIGS. 5-5A, when the one or more heating elements or surfaces 310 are heated, such heat can cause the spring 40, 40A in the one or more locking mechanism assemblies 100, 100A to contract or increase in tension, causing the locking member 10, 10A of the one or more locking mechanism assemblies 100, 100A to move distally to a deployed or locking position. In such a deployed or locking position, the locking member 10, 10A of the one or more locking mechanism assemblies 100, 100A can engage a surface, slot, aperture or groove on the bottom portion (e.g., bottom rim) of the mug 200 to thereby securely couple the heating unit 300 to the bottom of the container 200. Once power to the one or more heating elements or surfaces 310 is ceased and they cool off, or where they are operated to cool (e.g., where theremoelectric heating/cooling elements 310 are used in the detachable unit 300), the spring 40, 40A in the one or more locking mechanism assemblies 100, 100A can decrease in tension, allowing the force exerted by the springs 30, 30A to exceed the force exerted by the springs 40, 40A, thereby causing the locking member 10, 10A of the one or more locking mechanism assemblies 100, 100A to move proximally to a retraced or unlocked position. In such a retracted or unlocked position, the locking member 10, 10A can disengage, decouple, and/or detach from the surface, slot, aperture or groove on the bottom portion (e.g., bottom rim) of the container 200, allowing the user to lift the container 200 away from the detachable unit 300 (e.g., to wash the container 200, such as in a dishwasher).

While the device shown in FIGS. 5A-5C is a container 200 that can hold a liquid, one of skill in the art will recognize that the device can be other types of drinkware or dishware or serverware or containers (e.g., cups, mugs, travel mugs, beer mugs, plates, bowls, patters, tureens, other serving dishes, carafes, liquid containers, baby bottles, sippy cups, reusable water bottles, bread baskets, tortilla warmers, lunch boxes, food storage containers). Further details of devices that can utilize detachable units 300 having one or more locking mechanism assemblies 100, 100A can be found U.S. application Ser. No. 14/712,313, which is incorporated herein in its entirety and should be considered a part of this specification. Additionally, the locking mechanism assemblies 100, 100A can be used in other devices (e.g., removable power packs for electric power tools, removable power packs for lighting equipment, such as outdoor lighting, computer docking stations, etc.).

While certain embodiments of the inventions have been described, these embodiments have been presented by way of example only, and are not intended to limit the scope of the disclosure. Indeed, the novel methods and systems described herein may be embodied in a variety of other forms. For example, though the features disclosed herein are in describe for drinkware containers, the features are applicable to containers that are not drinkware containers (e.g., bowls, serverware, food storage containers) and the invention is understood to extend to such other containers. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Though the features and ideas disclosed above may be related to actively heating or cooling food or beverage, the embodiments above may also be used to heat or cool air spaces, such as refrigeration devices, cold boxes, coolers, portable coolers, or portable refrigerators, or hot boxes, or warmer drawers, or heat chambers, or any other device that would benefit from the heating or cooling of the air within a defined cavity or chamber.

Of course, the foregoing description is that of certain features, aspects and advantages of the present invention, to which various changes and modifications can be made without departing from the spirit and scope of the present invention. Moreover, the heated or cooled dishware and drinkware need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed locking mechanism assemblies and the devices in which it's used.

What is claimed is:

1. A device comprising:
a first component;
a second component detachably coupleable to the first component, the second component comprising a surface and one or more locking mechanism assemblies mounted on the surface, the locking mechanism assembly comprising
a locking member configured to move between a retracted position and a deployed position,
a first spring coupled to a proximal portion of the locking member, the first spring configured to exert a force on the locking member in a first direction toward one of the retracted and deployed positions, and
a second spring coupled to the locking member, the second spring configured to exert a force on the locking member in a second direction opposite the first direction toward the other of the retracted and deployed positions, the second spring comprising a shape memory material, where the second spring moves to a pre-deformed state when exposed to heat, thereby increasing in tension such that the force exerted by the second spring on the locking member exceeds the force exerted on the locking member by the first spring, causing the locking member to move in the second direction, and wherein the second spring moves to a deformed state when cooled below a predetermined level, thereby decreasing in tension such that the force exerted by the first spring on the locking member exceeds the force exerted on the locking member by the second spring, causing the locking member to move in the first direction,
wherein the second component comprises one or more elements configured to generate one or more of heating and cooling of the surface to move the locking member to the deployed or retracted position to lock or unlock the second component to the first component.

2. The device of claim 1, wherein the first spring exerts a force on the locking member in the first direction toward the retracted position, and wherein second spring exerts a force on the locking member in the second direction toward the deployed position, wherein in the deployed position the second component is coupled to the first component and wherein in the retracted position the second component is decoupled from the first component.

3. The device of claim 1, wherein in the second spring is a leafspring.

4. The device of claim 3, wherein the leafspring extends generally transverse to a length of the locking member and to an axis of the first spring.

5. The device of claim 3, wherein the leaf spring extends through a bore across a body of the locking member.

6. The device of claim 1, wherein the second spring is a coil spring.

7. The device of claim 6, wherein the second spring extends along an axis generally parallel to an axis of the locking member and an axis of the first spring.

8. The device of claim 6, wherein the second spring extends from an opposite side of the proximal portion of the locking member than the first spring.

9. The device of claim 1, wherein the first component is a container and the second component is a detachable unit that transmits one or both of heating and cooling to a surface of the container when the unit is coupled to the container to heat or cool contents in the container.

10. A locking mechanism assembly, comprising
a locking member configured to move between a retracted position and a deployed position;
a first spring coupled to a proximal portion of the locking member, the first spring configured to exert a force on the locking member in the proximal direction toward the retracted position; and
a second spring coupled to the locking member, the second spring configured to exert a force on the locking member in a distal direction toward the deployed position, opposite to the direction of force exerted by the first spring,
wherein one of the first and second springs comprising a shape memory material that moves to a pre-deformed state when exposed to heat, thereby increasing in tension such that the force it exerts on the locking member exceeds the force exerted on the locking member by the other of the first and second springs, causing the locking member to move to the retracted or deployed position.

11. The assembly of claim 10, wherein when said one of the first and second springs comprising a shape memory material is not exposed to heat, it decreases in tension such that the force it exerts on the locking member is lower than the force exerted on the locking member by the other of the first and second springs, causing the locking member to move to the deployed or retracted position.

12. The assembly of claim 10, wherein in the second spring is a leafspring.

13. The assembly of claim 11, wherein the leafspring extends generally transverse to a length of the locking member and to an axis of the first spring.

14. The assembly of claim 11, wherein the leaf spring extends through a bore across a body of the locking member.

15. The assembly of claim 10, wherein the second spring is a coil spring.

16. The assembly of claim 15, wherein the second spring extends along an axis generally parallel to an axis of the locking member and an axis of the first spring.

17. The assembly of claim 16, wherein the second spring extends from an opposite side of the proximal portion of the locking member than the first spring.

18. The assembly of claim 10, further comprising a component surface on which the first and second springs are attached, the locking member configured to move in a direction generally parallel to a plane of the component surface.
